(19) United States
(12) Patent Application Publication
(10) Pub. No.: US 2025/0202085 A1
(43) Pub. Date: Jun. 19, 2025

(54) ELECTROLYTE FILLING OF BATTERY CELL

(71) Applicant: Rivian IP Holdings, LLC, Irvine, CA (US)

(72) Inventors: Gaurav SONONE, Freemont, CA (US); Christopher Surya KOMPELLA, Saratoga, CA (US); Rajeev DHIMAN, Pleasanton, CA (US)

(21) Appl. No.: 18/540,724

(22) Filed: Dec. 14, 2023

(51) Int. Cl. H01M 50/627; H01M 50/103; H01M 50/30

(52) U.S. Cl. CPC H01M 50/627; H01M 50/103; H01M 50/394; H01M 2220/20

(57) ABSTRACT

Battery cell assembly can include introducing a liquid electrolyte through an open face of a battery container that includes electrodes therein. Such open face filling advantageously allows faster filling of the battery cell and a larger area for displacing gas from the electrodes and can facilitate improved wetting of electrodes with the electrolyte. The battery container can include a bottom face connected to one or more sidewalls that extend upward from the bottom face to form the open face of the container. Such a process and configuration further can eliminate a fill port and plug on a battery container.

### INTRODUCTION

Batteries are often used as a source of power, including as a source of power for electric vehicles that include wheels that are driven by an electric motor that receives power from the battery.

Aspects of the subject technology can help reduce costs for battery cell manufacture and improve the reliability and/or serviceability of such battery cells for electric vehicles, which can help to mitigate climate change by reducing greenhouse gas emissions.

### SUMMARY

The present disclosure generally relates to battery cell assembly and battery cells made thereby including filling battery cells. A process can include introducing a liquid electrolyte through an open face of a container that includes electrodes therein. Advantageously, an area of the open face of the container can be from about 5% to less than 100% of an area of a bottom face of the container. In some aspects, the open face can have an area approximate an area of the bottom face. Battery cell containers can include a bottom face connected to one or more sidewalls that extend upward from the bottom face and form the open face (406) at a top of the one or more sidewalls.

In some implementations, the process can include applying pressure above atmospheric pressure to an interior of the container during or after introduction of the liquid electrolyte and/or applying a reduced pressure from atmospheric pressure, e.g., a vacuum, to an interior of the container before, during or after introducing the liquid electrolyte to the battery container. In some aspects, the process can include both or cycling between applying pressure or vacuum. Such process advantageously can displace gas from the electrodes and wet the electrodes with the electrolyte.

In other implementations, the introduction of electrolyte, application of pressure, application of vacuum or any or all thereof can be carried out in a hermetically sealed chamber and under an inert atmosphere.

In accordance with one or more implementations, a battery cell can include electrodes with a liquid electrolyte in a container, e.g., a prismatic container, in which the container excludes a fill port for introducing the liquid electrolyte. Such a container can also exclude a plug to seal the fill port and can include a vent to release gas.

In accordance with one or more other implementations, the electrodes in the battery cell can include a positive electrode having a cathode on a current collector and a negative electrode having a negative current collector and an anode, which may be formed in-situ on the negative current collector, e.g., an anode-free cell. The battery cell can further include a positive and a negative terminal, which can be used to electrically connect a load or charger to the battery cell.

In one or more implementations, a battery cell as described herein can be included in a building and/or movable apparatus, e.g., a vehicle. For example, such a battery cell can be configured to power one or more components or systems of a building and/or a vehicle.

### BRIEF DESCRIPTION OF THE DRAWINGS

Certain features of the subject technology are set forth in the appended claims. However, for purpose of explanation, several embodiments of the subject technology are set forth in the following figures.

FIG. 1A and FIG. 1B illustrate schematic perspective side views of example implementations of a vehicle having a battery pack in accordance with one or more implementations of the present disclosure.

FIG. 1C illustrates a schematic perspective view of a building having a battery pack in accordance with one or more implementations of the present disclosure.

FIG. 2A illustrates a schematic perspective view of a battery pack in accordance with one or more implementations of the present disclosure.

FIG. 2B illustrates schematic perspective views of various battery modules that may be included in a battery pack in accordance with one or more implementations of the present disclosure.

FIG. 2C illustrates a cross-sectional end view of a battery cell in accordance with one or more implementations of the present disclosure.

FIG. 2D illustrates a cross-sectional perspective view of a cylindrical battery cell in accordance with one or more implementations of the present disclosure.

FIG. 2E illustrates a cross-sectional perspective view of a prismatic battery cell in accordance with one or more implementations of the present disclosure.

FIG. 2F illustrates a cross-sectional perspective view of a pouch battery cell in accordance with one or more implementations of the present disclosure.

FIG. 3A illustrates a prismatic battery cell with a conventional fill port and plug.

FIG. 3B illustrates a process for introducing liquid electrolyte through the fill port of a prismatic battery cell.

FIG. 3C illustrates a top view of a prismatic battery cell showing a top cap including a fill port and vent.

FIG. 4A illustrates a prismatic battery cell with a fill port in accordance with implementations of the present disclosure.

FIG. 4B illustrates a prismatic battery cell and process for introducing electrolyte through an open face of the battery container in accordance with implementations of the present disclosure.

FIG. 5 illustrates a flow chart of example operations of introducing a liquid electrolyte through an open face of a battery container that includes electrodes therein in accordance with implementations of the present disclosure.

FIG. 6A, FIG. 6B, and FIG. 6C illustrate a prismatic battery cell with a cap offset from the battery container in accordance with implementations of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

As discussed in further detail hereinafter, a battery cell filled with liquid electrolyte according to processes of the present disclosure can be used to store and discharge electrical energy. A battery cell of the present disclosure can be used alone or multiple battery cells can be assembled or packaged together in the same housing, frame, or casing to form a battery subassembly, module and/or battery pack. Further, multiple battery subassemblies or modules can be assembled or packaged together to form a battery pack. The battery cells of a battery subassembly, module and/or pack can be electrically connected to generate a desired voltage output for the battery subassembly, module and/or pack. In addition, battery cells of the present disclosure can be assembled as a cell-to-pack configuration. The battery subassembly, module and/or pack in turn can be electrically connected to a power-consuming component, such as a vehicle and/or an electrical system of a building.

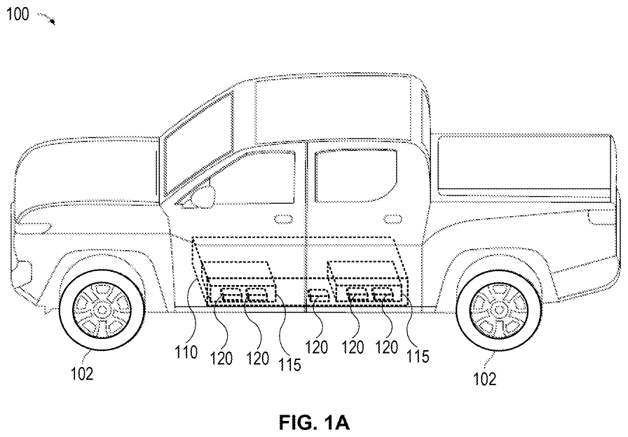

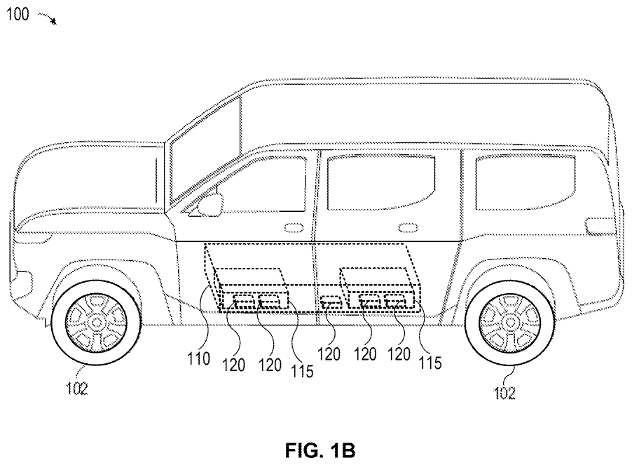

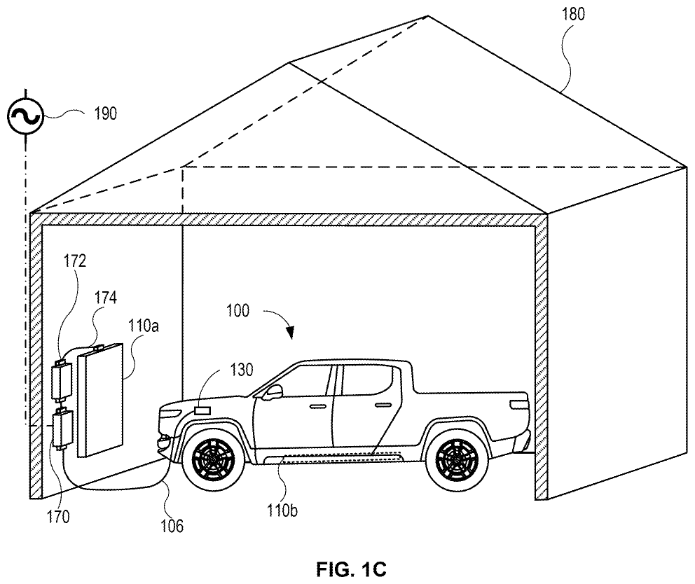

FIG. 1A is a diagram illustrating an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid). In various implementations, the vehicle 100 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each battery cell 120 can be included a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. For example, the building 180 may be a residential building, a commercial building, or any other building. As shown, in one or more implementations, a battery pack 110 may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs (as examples)).

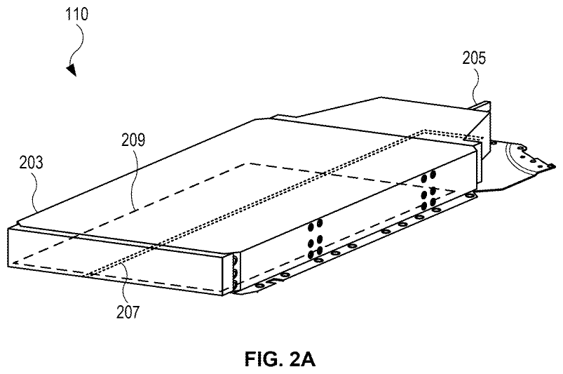

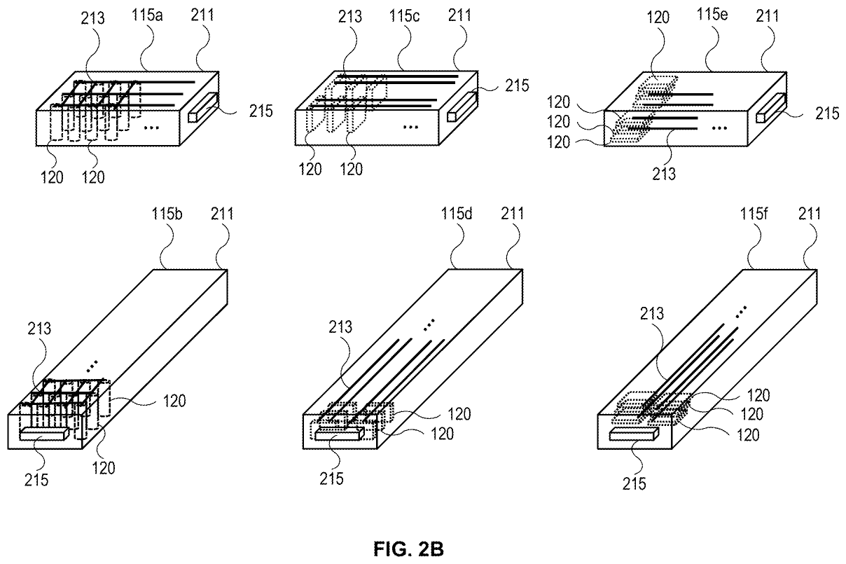

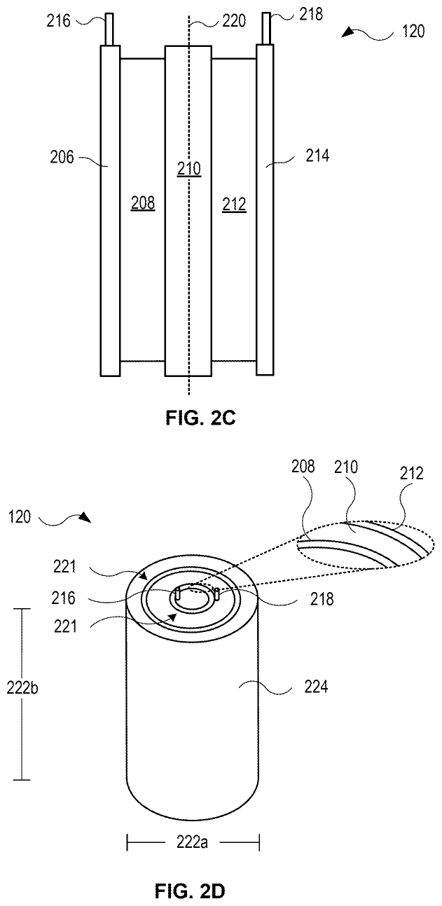

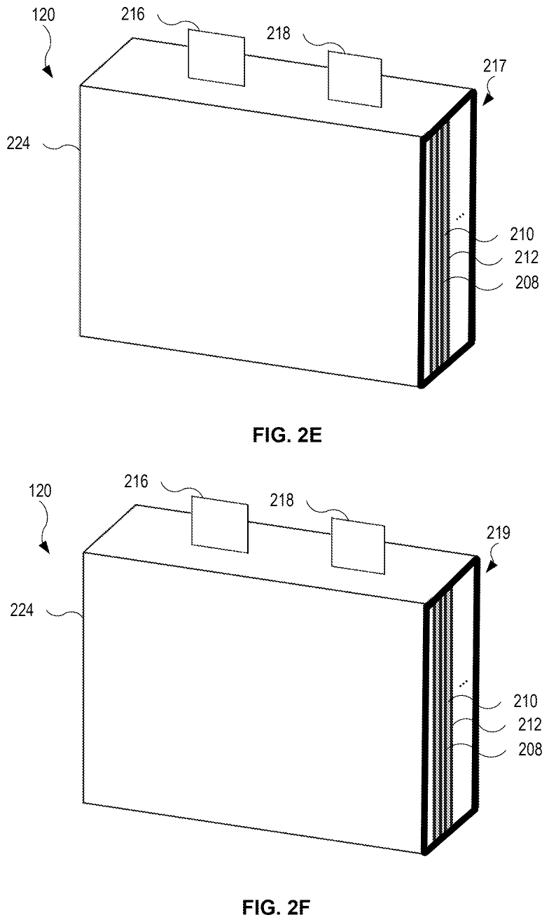

FIG. 2A illustrates an example of a battery pack 110. As shown, the battery pack 110 may include a battery pack frame 203 (e.g., a battery pack housing or pack frame). The battery pack frame 203 may house or enclose one or more battery modules and/or one or more battery cells, and/or other battery pack components of the battery pack 110. In one or more implementations, the battery pack frame 203 may include or form a shielding structure on an outer surface thereof (e.g., a bottom thereof and/or underneath one or more battery module, battery units, batteries, and/or battery cells) to protect the battery module, battery units, batteries, and/or battery cells from external conditions (e.g., if the battery pack 110 is installed in a vehicle and the vehicle is driven over rough terrain, such as off-road terrain, trenches, rocks, rivers, streams, etc.).

The battery pack 110 may include battery cells (e.g., directly installed within the battery pack 110, or within batteries, battery units, and/or battery modules as described herein) and/or battery modules, and one or more conductive coupling elements for coupling a voltage generated by the battery cells to a power-consuming component, such as the vehicle 100 (shown in FIGS. 1A, 1B, and 1C) and/or an electrical system of the building 180 (shown in FIG. 1C). For example, the conductive coupling elements may include internal connectors and/or contactors that couple together multiple battery cells, battery units, batteries, and/or multiple battery modules within the battery pack frame 203 to generate a desired output voltage for the battery pack 110. The battery pack 110 may also include one or more external connection ports, such as an electrical contact 205 (e.g., a high voltage terminal or connector). As shown, the battery pack 110 may include an electrical contact 205 may electrically couple an external load (e.g., the vehicle or an electrical system of the building) to the battery modules and/or battery cells in the battery pack 110. In this regard, an electrical cable (e.g., cable/connector 106) may be connected between the electrical contact 205 and an electrical system of a vehicle or a building, to provide electrical power to the vehicle or the building.

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules, battery units, batteries, and/or battery cells within the battery pack frame 203, such as by distributing fluid through the battery pack 110. The thermal control structures 207 may form a part of a thermal/temperature control or heat exchange system that includes one or more thermal components 209, which may include plates or bladders that are disposed in thermal contact with one or more battery modules and/or battery cells disposed within the battery pack frame 203. The one or more thermal components 209 may be positioned in contact with one or more battery modules, battery units, batteries, and/or battery cells within the battery pack frame 203. The one or multiple thermal control structures 207 may be provided for each of several top and bottom battery module pairs.

FIG. 2B depicts various examples of battery modules that may be disposed in a battery pack (e.g., within the battery pack frame 203 of the battery pack 110, shown in FIG. 2A). In an example of FIG. 2B, a battery module 115a is shown that includes a battery module housing 211 having a rectangular cuboid shape with a length that is substantially similar to its width. In this example, the battery module 115a includes battery cells 120 implemented as cylindrical battery cells. The battery module 115a further includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery module 115a may further include a bus bar 215 that functions as a charge collector. For example, the bus bar 215 may be electrically coupled to the interconnect structure 213 to collect the charge generated by the battery cells 120 to provide a high voltage output from the battery module 115a.

FIG. 2B also shows a battery module 115b having an elongate shape. The battery module 115b may include a battery module housing 211 in which the length of the (e.g., extending along a direction from a front end to a rear end of the battery module housing 211) is substantially greater than a width (e.g., in a transverse direction to the direction from the front end to the rear end) of the battery module housing 211). In this regard, the battery module 115b (representative of one or more similar battery modules) may span the entire front-to-back length of a battery pack within a battery pack frame. As shown, the battery module 115a may further include an interconnect structure 213 electrically coupled to a bus bar 215, allowing the bus bar 215 may be electrically coupled to the interconnect structure 213 to collect the charge generated by battery cells 120 of the battery module 115b to provide a high voltage output from the battery module 115b.

In the implementations of battery module 115a and battery module 115a, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115c having a battery module housing 211 with a rectangular cuboid shape with a length that is substantially similar to its width and including battery cells 120 implemented as prismatic battery cells. In this example, the battery module 115c includes rows and columns of battery cells 120 that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery module 115c may include a bus bar 215 that functions as a charge collector. For example, the bus bar 215 may be electrically coupled to the interconnect structure 213 to collect the charge generated by the battery cells 120 to provide a high voltage output from the battery module 115c.

FIG. 2B also shows a battery module 115d including prismatic battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. As shown, the battery module 115d may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115d.

As another example, FIG. 2B also shows a battery module 115e having a battery module housing 211 having a rectangular cuboid shape with a length that is substantially similar to its width. The battery module housing 211 may carry battery cells 120, each of which being implemented as pouch battery cells. In this example, the battery module 115e includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery module 115e may also include a bus bar 215 electrically coupled to the interconnect structure 213. For example, the bus bar 215 may be electrically coupled to the interconnect structure 213 to collect the charge generated by the battery cells 120 to provide a high voltage output from the battery module 115e.

FIG. 2B also shows a battery module 115f including pouch battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. In this regard, the battery module 115f (representative of one or more similar battery modules) may span the entire front-to-back length of a battery pack within a battery pack frame. As shown, the battery module 115f may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115f.

In various implementations, a battery pack (e.g., battery pack 110 shown in FIG. 2A) may be provided with one or more of any of the battery modules 115a, 115b, 115c, 115d, 115e, and 115f. In one or more other implementations, a battery pack may be provided without any of the battery modules 115a, 115b, 115c, 115d, 115e, and 115f (e.g., in a cell-to-pack implementation).

In one or more implementations, battery modules in any of the implementations of FIG. 2B may be coupled (e.g., in series) to a current collector of a battery pack. In one or more implementations, the current collector may be coupled, via a high voltage harness, to one or more external connectors on a battery pack (e.g., electrical contact 205 of the battery pack 110, shown in FIG. 2A). In one or more implementations, a battery pack may be provided without any battery modules 115. For example, in a cell-to-pack configuration, the battery cells 120 are arranged directly into a battery pack without assembly into a battery module (e.g., without including the battery module housing 211). For example, a battery pack frame of a battery pack (e.g., the battery pack frame 203 of the battery pack 110 shown in FIG. 2A) may include or define a plurality of structures for positioning of the battery cells 120 directly within the battery pack frame.

FIG. 2C illustrates a cross-sectional end view of a portion of a battery cell 120. As shown in FIG. 2C, a battery cell 120 may include an anode 208, an electrolyte 210, and a cathode 212. As shown, the anode 208 may include or be electrically coupled to a first current collector 206 (e.g., a metal layer such as a layer of copper foil or other metal foil). As shown, the cathode 212 may include or be electrically coupled to a second current collector 214 (e.g., a metal layer such as a layer of aluminum foil or other metal foil). As shown, the battery cell 120 may include a first terminal 216 (e.g., a negative terminal) coupled to the anode 208 (e.g., via the first current collector 206) and a second terminal 218 (e.g., a positive terminal) coupled to the cathode (e.g., via the second current collector 214). In various implementations, the electrolyte 210 may be a liquid electrolyte or a solid electrolyte layer. In one or more implementations (e.g., implementations in which the electrolyte 210 is a liquid electrolyte layer), the battery cell 120 may include a separator layer 220 that separates the anode 208 from the cathode 212. In one or more implementations in which the electrolyte 210 is a solid electrolyte layer, the solid electrolyte layer may act as both as a separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. As shown, the battery cell 120 may include a separator layer 220 that separates the anode 208 from the cathode 212. In an implementation in which the battery cell 120 is implemented as a lithium-ion battery cell, the electrolyte 210 may include a lithium salt in an organic solvent. The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cells 120 are implemented as lithium-ion battery cells, some or all of the battery cells 120 in a battery module 115, battery pack 110, or other battery or battery unit may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials.

In various implementations, the anode 208, the electrolyte 210, and the cathode 212 of FIG. 2C can be packaged into a battery cell housing having any of various shapes, and/or sizes, and/or formed from any of various suitable materials. For example, battery cells 120 can have a cylindrical, rectangular, square, cubic, flat, pouch, elongated, or prismatic outer shape. As depicted in FIG. 2D, for example, a battery cell such as the battery cell 120 may be implemented as a cylindrical cell. In the example of FIG. 2D, the battery cell 120 includes a cell housing 224 having a cylindrical outer shape, which includes dimension 222a (e.g., cylinder diameter, battery cell diameter) and a dimension 222b (e.g., cylinder length). As shown in the enlarged view, the anode 208, the electrolyte 210, and the cathode 212 may be rolled into one or more substantially cylindrical windings 221. As shown, one or more windings 221 of the anode 208, the electrolyte 210, and the cathode 212 (e.g., and/or one or more separator layers such as separator layer 220) may be disposed within the cell housing 224. For example, a separator layer may be disposed between adjacent ones of the windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a bus bar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

For example, FIG. 2E illustrates an example in which the battery cell 120 is implemented as a prismatic cell. As shown in FIG. 2E, the battery cell 120 may have a cell housing 224 having a right prismatic outer shape. As shown, one or more layers of the anode 208, the cathode 212, and the electrolyte 210 disposed therebetween may be disposed (e.g., with separator materials between the layers) within the cell housing 224 having the right prismatic shape. As examples, multiple layer of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224 having the right prismatic shape. In the implementation of FIG. 2E, the cell housing 224 has a relatively thick cross-sectional width 217 and is formed from a rigid material. For example, the cell housing 224 in the implementation of FIG. 2E may be formed from a welded, stamped, deep drawn, and/or impact extruded metal sheet, such as a welded, stamped, deep drawn, and/or impact extruded aluminum sheet. For example, the cross-sectional width 217 of the cell housing 224 of FIG. 2E may be as much as, or more than 1 millimeter (mm) to provide a rigid housing for the prismatic battery cell. In one or more implementations, the first terminal 216 and the second terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the first terminal 216 and the second terminal 218 outside the cell housing 224 in order to contact an interconnect structure (e.g., interconnect structure 213 shown in of FIG. 2B). However, this implementation of FIG. 2E is also illustrative and yet other implementations of the battery cell 120 are contemplated.

For example, FIG. 2F illustrates an example in which the battery cell 120 is implemented as a pouch cell. As shown in FIG. 2F, one or more layers of the anode 208, the cathode 212, and the electrolyte 210 disposed therebetween may be disposed (e.g., with separator materials between the layers) within the cell housing 224 that forms a flexible or malleable pouch housing. In the implementation of FIG. 2F, the cell housing 224 has a relatively thin cross-sectional width 219. For example, the cell housing 224 in the implementation of FIG. 2F may be formed from a flexible or malleable material (e.g., a foil, such as a metal foil, or film, such as an aluminum-coated plastic film). For example, the cross-sectional width 219 of the cell housing 224 of FIG. 2F may be as low as, or less than 0.1 mm, 0.05 mm, 0.02 mm, or 0.01 mm to provide flexible or malleable housing for the pouch battery cell. In one or more implementations, the first terminal 216 and the second terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the first terminal 216 and the second terminal 218 are formed on the same side (e.g., a top side) of the battery cell 120. However, this is merely illustrative and, in other implementations, the first terminal 216 and the second terminal 218 may formed on two different sides (e.g., opposing sides, such as a top side and a bottom side) of the battery cell 120. The first terminal 216 and the second terminal 218 may be formed on a same side or difference sides of the cylindrical cell of FIG. 2D in various implementations.

In one or more implementations, a battery module 115, a battery pack 110, a battery unit, or any other battery may include some battery cells 120 that are implemented as solid-state battery cells and other battery cells 120 that are implemented with liquid electrolytes for lithium-ion or other battery cells having liquid electrolytes. One or more of the battery cells 120 may be included a battery module 115 or a battery pack 110, such as to provide an electrical power supply for components of the vehicle 100, the building 180, or any other electrically powered component or device. The cell housing 224 of the battery cell 120 can be disposed in the battery module 115, the battery pack 110, or installed in any of the vehicle 100, the building 180, or any other electrically powered component or device.

### Electrolyte Filling

As discussed above, a battery cell (e.g., battery cell 120) prepared in accordance with the present disclosure can be used to store and discharge electrical energy and implemented in a building and/or movable apparatus. Battery cells filled with electrolyte according to implementations of the present disclosure can be used in lithium or sodium ion battery cells and battery cells that include a metal such as lithium or sodium metal battery cell.

Filling a battery cell with liquid electrolyte tends to be among the process steps with the greatest time period in battery cell assembly, particularly for mass-scale battery manufacturing. The long time period for electrolyte filling is caused entrapped air that needs to be removed from various components of the electrodes such as the cathode, anode, etc. and is further caused by the relatively low permeability and wettability of the electrodes to the electrolyte. Conventional prismatic battery cells have a relatively small fill port, e.g., a diameter from 2-4 mm, located on a cap with one or more terminals for introducing electrolyte after the cap is fitted on the battery container. Pushing electrolyte through such a fill port into a battery cell while also allowing trapped air in the porous electrodes to escape out of the cell takes considerable time and often requires multiple electrolyte filling stations, which adds to costs.

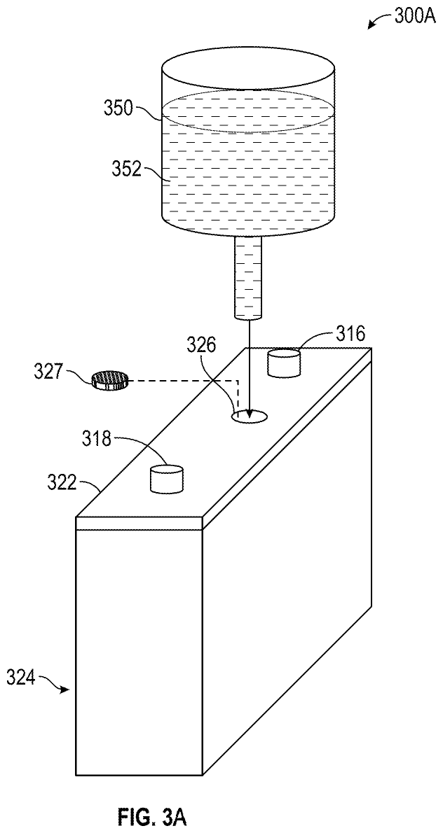

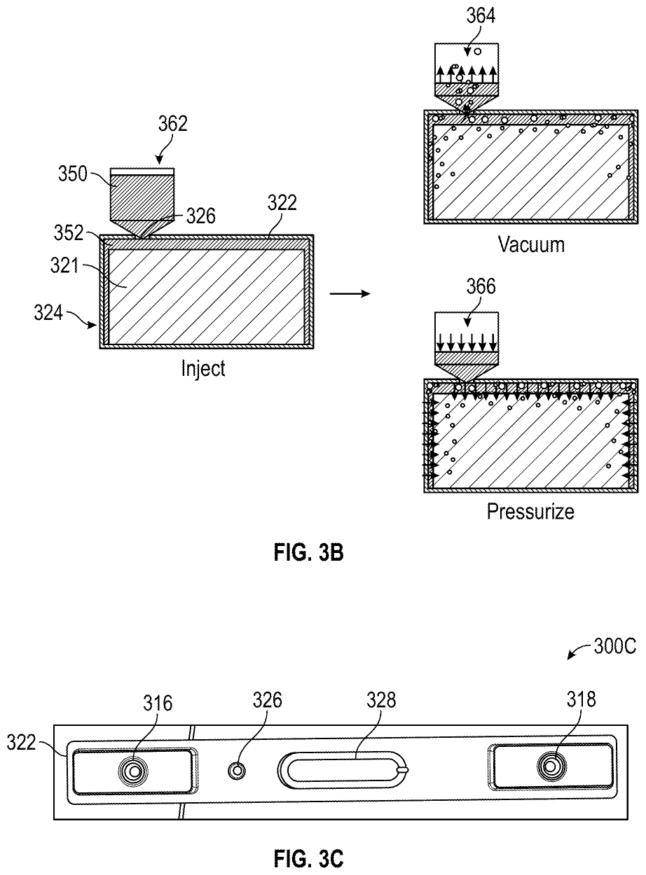

FIGS. 3A, 3B and 3C illustrate a conventional prismatic battery cell with a fill port on and a process of introducing liquid electrolyte through the fill port to assemble a battery cell. As shown in FIG. 3A, a battery cell ready for electrolyte filling includes a fill port (326) where electrolyte (352) is introduced from a source container (350) into the battery cell container (324), e.g., can. Although not shown, container 324 includes electrodes within the container and electrically connected to terminals 316 and 318. The fill port is typically on a top cap of the container that includes one or more terminal, but sometimes the fill port can be on a sidewall or bottom face of the container. For this example, fill port (326) is a top cap (322) of container 324 and further includes a vent (328) for releasing gases after filling the container. FIG. 3B illustrates a process of filling a battery cell having electrodes therein by introducing electrolyte through a conventional fill port, e.g., a fill port having an area of less than about 20 mm². As shown in this figure a source of electrolyte (350) can be connected to fill port 326 to introduce liquid electrolyte. By physically connecting the electrolyte source to the fill port, the battery cell can be filled outside of a chamber that controls the atmosphere around the battery cell. The process includes introducing electrolyte to the container (362) evacuating the container (364) and applying pressure (366) to the interior of the container via the fill port. Such a process results in gases escaping through the fill port at certain times causing ‘burping” of gases through the fill port and can be time consuming. Further, such a process typically includes multiple filling stations to complete filling the battery cell with electrolyte. Additional, after the container is filled with electrolyte, a fill port plug (327) is fitted onto the fill port to seal the fill port and prevent liquid electrolyte from escaping the container.

In contrast to a conventional liquid electrolyte filling process using a small fill port, the subject technology introduces liquid electrolyte through a large orifice and in some aspects through an open face of a battery cell container. Such a process advantageously can eliminate a fill port from the battery cell container as well as reduce or eliminate associated bill of material (BOM) components (e.g., seal, fill plug, etc.). Additionally, eliminating a fill port also means elimination of a seal from the cell (one less potential failure point) and associated manufacturing processes (laser welding as well as inspection) to ensure seal integrity.

In addition, a larger filling area for introducing liquid electrolyte to the container advantageously creates a much larger area for air to escape and can enable a single-step filling process. It is believed that a reduction of more than 35% in the cost and more than 20% in the footprint of a traditional battery cell assembly line can be achieved by an open face electrolyte filling process.

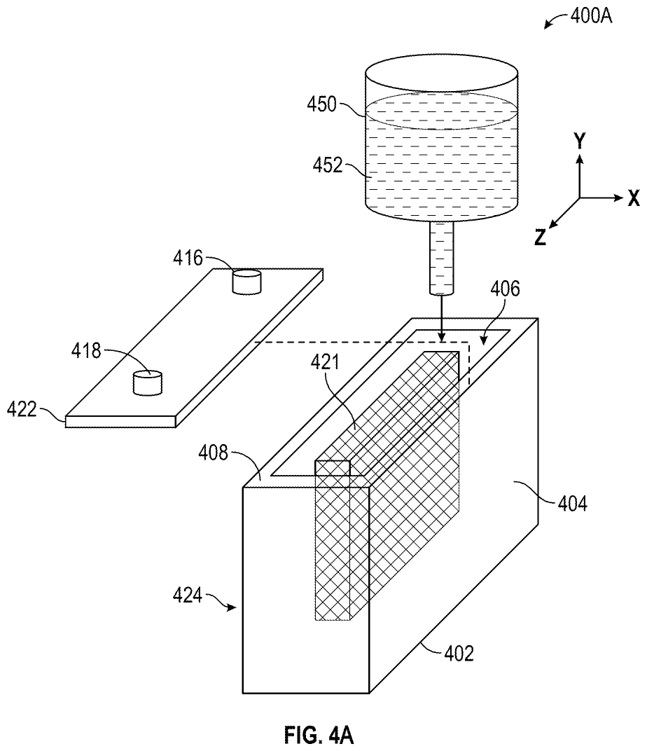

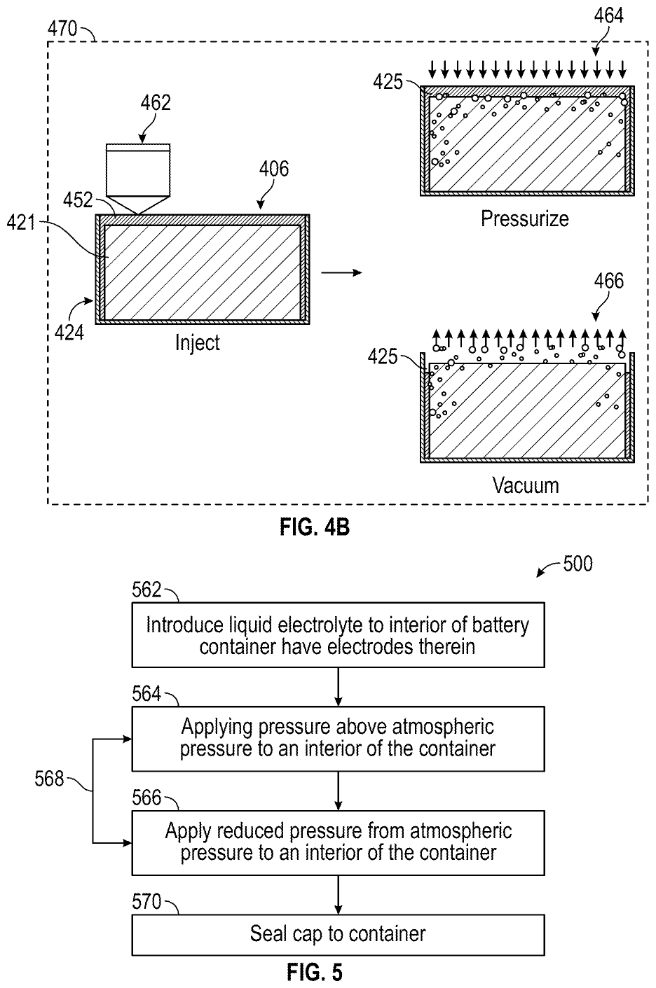

In some implementations of the subject technology, a process for filling a battery cell can include introducing a liquid electrolyte through an open face of a container (e.g., can) that has electrodes in the container. FIG. 4A and FIG. 4B illustrate an exemplary battery cell container that advantageously can be filled with electrolyte according to aspects of the present disclosure. As shown in FIG. 4A, the battery cell can be in the form of a prismatic cell. However, the processes of the present disclosure can be adapted to other forms of battery cells. FIG. 4A illustrates a battery cell ready for electrolyte filling includes container (424) having a bottom face (402) connected to one or more sidewalls (404) that extend upward from the bottom face (402) and form an open face (406) at a top (408) of the one or more sidewalls (404). For this example, the bottom face is connected to four sidewalls that extend upward from the bottom face and form a rectangular open face at the top of the four sidewalls of a prismatic cell.

As further shown in FIG. 4A, the battery container can have dimensions aligned with a X, Y and Z axes. In one aspect the container can have a length, e.g., along the Z axis of from about 50 mm to about 1,500 mm, a width (sometimes referred to as a height), e.g., along Y axis, similar to the length, e.g., of from about 50 mm to about 1,500 mm, and a thickness, e.g., along the X axis, of from about 5 mm to about 100 mm. In some aspects the container can have a length of from about 100 mm to about 1500 mm, such as from about 200 mm to about 500 mm and a width of from about 50 mm to about 300 mm, such as from about 100 mm to about 200 mm, and a thickness of from about 5 mm to about 50 mm, such as from about 20 mm to about 30 mm. For example, a battery cell in the form of a blade can have a length of from about 800 mm to about 1,100 mm, a width of from about 60 mm to 120 mm and a thickness of from about 8 mm to 20 mm. A smaller prismatic battery cell container can have a length and width of from about 50 mm to about 400 mm and a thickness of from about 5 mm to about 40 mm.

In implementations of the present disclosure, the open face of the container defined by the sidewalls has the same dimensions and thus approximately the same area as an area defined by the bottom face. For example, the area of the open face (406) can be at least about 250 mm², e.g., from at least about 400 mm², 800 mm², 1,000 mm², 1,500 mm², 2,000 mm², 4,000 mm², 6,000 mm², etc. and higher and any value therebetween and can range from about 250 mm² to about 150,000 mm², for example.

Further, container 424 includes electrodes (421) within the container. Although not shown for illustrative convenience, the electrodes (421) can be electrically connected to terminals on a cell cap prior to introducing liquid electrolyte to the container. In such a configuration, the cap would be offset from the open face during the introduction of liquid electrolyte, e.g., offset from the top of the one or more side walls such that the open face is completely exposed. As shown in FIG. 4A, cell cap 422 is completely disconnected from the electrodes and the container. In this implementation, cell cap 422 includes a first terminal 416 and a second terminal 418 on cap 422. However, cell cap 422 excludes a fill port. Advantageously, since the battery cell of this implementation does not include a fill port, a plug to seal the fill port is also excluded, as well as a process of sealing the fill port.

In implementations, the cell cap (422) or other object can block part of the area of open face during the introduction of electrolyte such that the area of the open face is from about 5% to less than 100% of an area of the bottom face, e.g., from about 20% to less than 100% or from about 50% to less than 100% of the area of the bottom face.

In certain implementations, a battery cell can be filled by introducing a liquid electrolyte through an open face of a container that includes electrodes therein. Eliminating a fill port would reduce pressure losses associated with the flow of electrolyte from the source container to the battery container. Further, the process advantageously can include applying pressure above atmospheric pressure to an interior of the container during or after introduction of the liquid electrolyte. For example, a pressure of up to about 15 psig (pounds per square inch gauge) (a gauge pressure measurement) can be applied to an interior of the container having electrolyte and electrodes therein. Applying such an elevated pressure facilitates displacement of gases entrapped in the electrodes, which tend to be porous materials, with the liquid electrolyte. Such elevated pressure further promotes wetting of the electrodes with the electrolyte. In some instances, the wetting of electrodes by the present process can reduce or eliminate a soaking period of battery assembly and can improve the quality and cyclability of battery cells prepared by the subject technology by promoting a higher amount of electrode wetting.

Additionally, before, during or after introducing the liquid electrolyte to the battery container, a reduced pressure from atmospheric pressure, e.g., vacuum, can be applied to an interior of the container. For example, a reduced pressure of from below atmospheric pressure down to about −99 kPa (gauge) can be applied to an interior of the container having electrolyte and electrodes therein. Applying such a vacuum can have the same effect as the application of pressure, to displace gas from the electrodes and wet the electrodes with the electrolyte. Further, the process can cycle between applying pressure above atmospheric pressure to an interior of the container and applying a reduced pressure from atmospheric pressure to the interior of the container.

FIG. 4B and FIG. 5 illustrate a process of filling a battery cell according to one or more implementations of the present disclosure. As shown in FIG. 4B, the battery cell can be placed in a hermetically sealed chamber (470) and under a low moisture atmosphere, e.g., dry air, nitrogen, argon, etc. That is, liquid electrolyte (452) can be introduced (462, 562) through the open face (406) of the container (424) that includes electrodes therein (421) while within chamber 470 and under an inert atmosphere. Further the chamber can be pressurized and evacuated to apply pressure (464, 564) above atmospheric pressure to an interior (425) of the container (424) and to apply a reduced pressure (466, 566) from atmospheric pressure to the interior of the container, respectively. Further, the process can be cycle (568) between applying pressure (464, 564) and applying a reduced pressure (466, 566) to the interior of the container (425). The application of pressure and reduced pressure can have the effect of displacing gas from the electrodes and to wet the electrodes with the electrolyte. Such a cycling process can reduce or eliminate a soaking period of battery assembly and can improve the quality and cyclability of battery cells by promoting a higher amount of wetting of the electrodes by electrolyte.

After filling the battery container with electrolyte, the open face of the container can be sealed. For example, and with reference to FIG. 4A and FIG. 5, cap 422 can be placed on the top (408) of the sidewalls (404) and to sealed (570) to container (424) with the electrolyte (452) introduced therein. The cap can be sealed by laser welding the cap to the one or more sidewalls or by crimping the cap to the one or more sidewalls, for example. Further, if terminals on the cap is not electrically connected to the electrodes within the battery container, the one or more terminals on the cap can be electrically connected to the electrodes within the battery container prior to sealing the cap on the container.

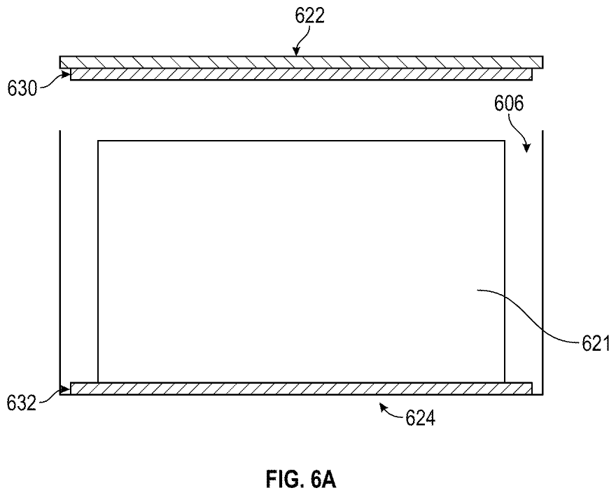

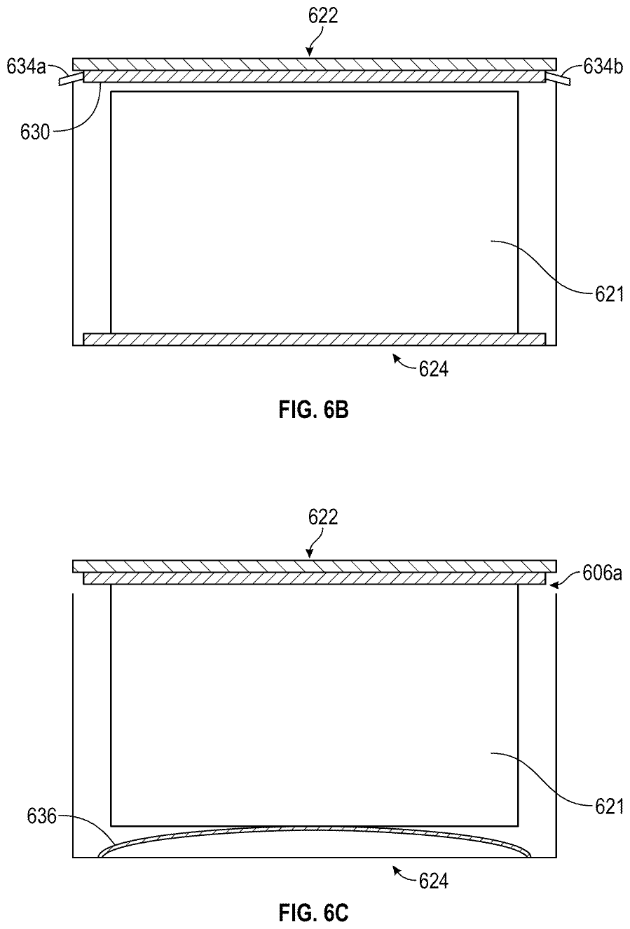

Regarding formation degassing, that can still be achieved without a traditional fill port by maintaining an open face for degassing or configuring a cap to a container to be offset from the container while degassing occurs. For example, FIGS. 6A-6C illustrate an exemplary battery cell container in the form of a prismatic cell in which the cap (622) is offset from the open face (606) of the container (624) with electrodes (621), e.g., a jellystack, in the container. In this example, the cap (622) can include an insulator (630) and the container (624) can include an insulator (632) between the electrodes (621) and the container (624). FIG. 6B and FIG. 6C show configurations to maintain the cap offset from the container during a degassing period after filling the container with electrolyte and before sealing the cap. In particular, FIG. 6B shows insulator (630) with breakaway standoffs (634a, 634b) to hold cap (622) off of a top surface of the container. The breakaway standoffs (634a, 634b) would not completely surround the cap such that gasses from within the container can escape from a gap between the cap and container. FIG. 6C illustrates an example in which insulator 636 in the container 624 can be bowed or otherwise configured to act as a spring such that the electrodes 621 extend upward to hold cap 622 above the open face (606) of container 624 forming a gap (606a) between the container and the cap such that gasses can escape the container. Other approaches to offset the cap from the container include holding the cap with equipment, tooling or a fixturing to achieve the same purpose. After degassing is complete, the cap can be pressed onto the container and sealed as described earlier.

In implementations of the present disclosure, a battery cell can be assembled having electrodes with a liquid electrolyte in a container, e.g., a prismatic container, in which the container excludes a fill port for introducing the liquid electrolyte. Advantageously, such a battery cell further excludes a plug sealing the fill port. However, in certain aspects, a battery cell of the present disclosure can include a vent such as a vent on a top face of the battery container, which allows gas to escape from an interior of the container.

In some aspects, a battery cell can include electrodes therein, such as a jelly stack composed of a positive electrode including a cathode active material. Such cathode active materials can be composed of, without limitation: one or more metal oxides such as a sodium metal oxide or lithium metal oxide (e.g., a lithium cobalt oxide, a lithium manganese oxide, a lithium nickel manganese cobalt oxide (NMC), or the like) and/or a metal phosphate, such as a lithium iron phosphate, lithium manganese phosphate, etc. or combinations thereof. The electrodes further include a negative electrode including an anode active material, which can be composed of, without limitation: graphitic carbon (e.g., ordered or disordered carbon with sp² hybridization, artificial or natural graphite, or blends thereof), a metal, such as sodium metal, lithium metal, metal alloys such as Li—Mg, Li—Al, Li—Ag alloys, a metal oxide, e.g., lithium titanate, silicon, a silicon-based material (e.g., silicon-based carbon composite, oxide, carbide, a pre-lithiated silicon material), etc. or a combination of any two or more thereof.

In some aspects, anodes that can be included in a battery cell in accordance with the present disclosure include an anode that may be formed in situ on a current collector. For example, an electrode can include a current collector (e.g., a metal foil such as a copper foil or carbon foil) with an in situ-formed anode (e.g., Na metal, Li metal) on a surface of the current collector facing a separator. In such examples, a battery cell may be configured to lack an anode active material in an uncharged state.

The battery cell can further include a separator between the cathode and anode. Useful separators that may be included in a battery cell of the present disclosure may be composed of, without limitation: a polymer such as polyethylene, polypropylene, polyolefin, and/or polyamide, a ceramic, glass, or other insulating materials, or any combination thereof.

Any liquid electrolyte can benefit from the processes of the present disclosure including non-aqueous electrolytes. Liquid electrolytes can include, without limitations, a salt dissolved in a solvent medium. A wide variety of solvent media can be included with a liquid electrolyte of the present disclosure such as carbonates, ethers and acetates, for example. In one aspect of the present disclosure, the electrolyte includes one or more carbonate solvents such as dimethyl carbonate (DMC), diethyl carbonate (DEC), and ethyl methyl carbonate (EMC), ethylene carbonate (EC), propylene carbonate (PC), vinylene carbonate (VC), fluoroethylene carbonate (FEC), vinyl ethylene carbonate (VEC), etc. or mixtures thereof; and/or one or more acetate solvents such as ethyl acetate (EA), methyl acetate (MA), etc. or mixtures thereof. For lithium ion battery cells, a variety of lithium salts may be added to the electrolyte such as lithium hexafluorophosphate (LiPF₆) lithium tetrafluoroborate (LiBF₄), lithium perchlorate (LiClO₄), lithium hexafluoroarsenate (LiAsF₆), lithium triflate (LiSO₃CF₃), lithium bis(fluorosulfonyl)imide (LiFSI), lithium bis(trifluoromethanesulfonyl)imide (LiTSFSI), etc., or a mixture thereof.

Aspects of the subject technology can help reduce costs for battery cell manufacture and improve the reliability and/or serviceability of such battery cells for electric vehicles. For example, battery cells prepared according to aspects of the present disclosure can have improved quality and cycle life. Batteries with such characteristics can help to mitigate climate change by reducing and/or preventing additional greenhouse gas emissions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A process, comprising:
introducing a liquid electrolyte through an open face of a container that includes electrodes therein;
wherein the container has a bottom face connected to one or more sidewalls that extend upward from the bottom face and form an open face at a top of the one or more sidewalls, wherein the area of the open face is from about 5% to less than 100% of an area of the bottom face.

2. The process of claim 1, further comprising, after introducing the liquid electrolyte, applying pressure above atmospheric pressure to an interior of the container to displace gas from the electrodes and wet the electrodes with the electrolyte.

3. The process of claim 1, further comprising after introducing the liquid electrolyte, applying a reduced pressure from atmospheric pressure to an interior of the container to displace gas from the electrodes and wet the electrodes with the electrolyte.

4. The process of claim 1, further comprising, after introducing the liquid electrolyte, cycling between applying pressure above atmospheric pressure to an interior of the container and applying a reduced pressure from atmospheric pressure to the interior of the container.

5. The process of claim 4, wherein the cycling occurs in a hermetically sealed chamber and under an inert atmosphere.

6. The process of claim 1, wherein introducing the electrolyte to the container occurs in a hermetically sealed chamber and under an inert atmosphere.

7. The process of claim 1, further comprising sealing a cap over the open face and to the one or more sidewalls of the container to seal the container with the electrolyte introduced therein.

8. The process of claim 1, wherein the area of the open face is from about 20% to less than 100% of the area of the bottom face.

9. The process of claim 1, wherein the area of the open face is at least 250 mm².

10. The process of claim 1, wherein the container is in a form of a prismatic container.

11. A process, comprising:
introducing a liquid electrolyte through an open face of a container that includes electrodes therein;
wherein the container has a bottom face connected to one or more sidewalls that extend upward from the bottom face and form an open face at a top of the one or more sidewalls, wherein the open face has an area approximate an area of the bottom face.

12. The process of claim 11, further comprising, after introducing the liquid electrolyte, cycling between applying pressure above atmospheric pressure to an interior of the container and applying a reduced pressure from atmospheric pressure to the interior of the container.

13. The process of claim 12, wherein introducing the electrolyte to the container occurs in an hermetically sealed chamber and under an inert atmosphere.

14. The process of claim 11, wherein a cap is electrically connected to the electrodes in the container but offset from the open face during the introduction of liquid electrolyte.

15. The process of claim 11, wherein introducing the electrolyte to the container occurs in an hermetically sealed chamber and under an inert atmosphere.

16. A battery cell, comprising
electrodes with a liquid electrolyte in a prismatic container, wherein the prismatic container excludes a fill port for introducing the liquid electrolyte.

17. The battery cell of claim 16, wherein the prismatic container has a length of from about 50 mm to about 1,500 mm, a width of from about 50 mm to about 1,500 mm and a thickness of from about 5 mm to about 100 mm; and wherein the prismatic container has a top face with one or more terminals in which the top face excludes the fill port.

18. The battery cell of claim 16, wherein the prismatic container has a length of from about 50 mm to about 400 mm, a width of from about 50 mm to about 400 mm and a thickness of from about 5 mm to about 40 mm; and wherein the prismatic container has a top face with one or more terminals in which the top face excludes the fill port.

19. The battery cell of claim 16, wherein the top face includes a vent which allows gas to escape from an interior of the prismatic container.

20. A vehicle comprising the battery cell of claim 16.
